(19) United States
(12) Patent Application Publication
(10) Pub. No.: US 2012/0035922 A1
(43) Pub. Date: Feb. 9, 2012

(54) METHOD AND APPARATUS FOR CONTROLLING WORD-SEPARATION DURING AUDIO PLAYOUT

(76) Inventor: Martin D. Carroll, Watchung, NJ (US)

(21) Appl. No.: 12/850,702

(22) Filed: Aug. 5, 2010

(51) Int. Cl. G10L 15/00; G06F 17/00

(52) U.S. Cl. 704/231; 700/94; 704/E15.001

(57) ABSTRACT

A word-separation control capability is provided herein. An apparatus having a word-separation control capability includes a processor configured for controlling a length of separation between adjacent words of audio during playout of the audio. The processor is configured for analyzing a locator analysis region of buffered audio for identifying boundaries between adjacent words of the buffered audio, and, for each identified boundary between adjacent words, associating a boundary marker with the identified boundary. The locator analysis region of the buffered audio may be analyzed using syntactic and/or non-syntactic speech recognition capabilities. The boundary markers may all have the same thickness, or the thickness of the boundary markers may vary based on the length of separation between the adjacent words of the respective boundaries. The boundary markers are associated with the buffered audio for use in controlling the word-separation during the playout of the audio.

### FIELD OF THE INVENTION

The invention relates generally to audio playout and, more specifically but not exclusively, to controlling characteristics of audio playout.

### BACKGROUND

There is significant demand for products that assist people in learning foreign languages. While many people are able to read or speak a foreign language, many of those people are not always as skilled in listening comprehension for the foreign language. For example, for a person learning a foreign language, when the person talks to a native speaker of that language, the person often asks the native speaker to slow down, pause, and/or repeat what was previously said by the native speaker. In some cases, a person attempting to learn a foreign language may listen to a radio station that is broadcast in that foreign language. Disadvantageously, however, people on the radio tend to speak in a manner that is not conducive to improvement of the listener's fluency (e.g., people on the radio often speak at full, or even accelerated, speed, and rarely slow down, pause, or repeat what they say—at least not in the manner needed by the person trying to learn the language). Thus, even with great mental effort by a person attempting to learn a foreign language, attempts by the person to improve his or her listening comprehension of the foreign language simply by listening to the foreign language as it is spoken are clearly ineffective.

### SUMMARY

Various deficiencies in the prior art are addressed by embodiments for enabling control of word-separation during audio playout.

In one embodiment, an apparatus having a word-separation control capability includes a processor configured for controlling a length of separation between adjacent words of audio during playout of the audio. The processor is configured for analyzing a locator analysis region of buffered audio for identifying boundaries between adjacent words of the buffered audio, and, for each identified boundary between adjacent words, associating a boundary marker with the identified boundary. The locator analysis region of the buffered audio may be analyzed using syntactic and/or non-syntactic speech recognition capabilities. The boundary markers may all have the same thickness, or the thickness of the boundary markers may vary based on the length of separation between the adjacent words of the respective boundaries. The boundary markers are associated with the buffered audio for use in controlling the word-separation during the playout of the audio.

### BRIEF DESCRIPTION OF THE DRAWINGS

The teachings herein can be readily understood by considering the following detailed description in conjunction with the accompanying drawings, in which:

FIG. 1 depicts a high-level block diagram of one embodiment of an audio player;

FIG. 2 depicts one embodiment of a buffer for use in the audio player of FIG. 1;

FIG. 3 depicts one embodiment of a method for analyzing audio within the buffer of FIG. 2 for identifying word boundaries and associating boundary markers with identified word boundaries;

FIG. 4 depicts one embodiment of a method for selecting a locator analysis region within the buffer of FIG. 2;

FIG. 5 depicts one embodiment of a method for playing audio from the buffer of FIG. 2;

FIG. 6 depicts one embodiment of a method for processing an incoming audio word for storage within the buffer of FIG. 2;

FIGS. 7A and 7B depict exemplary user control interfaces for the audio player of FIG. 1; and

FIG. 8 depicts a high-level block diagram of a computer suitable for use in performing the functions described herein.

To facilitate understanding, identical reference numerals have been used, where possible, to designate identical elements that are common to the figures.

### DETAILED DESCRIPTION OF THE INVENTION

An improved audio player capability is depicted and described herein. The improved audio player capability enables user control of the length of the separation between adjacent words during audio playout.

The improved audio player capability is applicable to non-broadcast audio and broadcast audio, thereby enabling radio listeners to control one or more aspects of the broadcast audio (e.g., speed, pauses, repetitions, and the like) and, thus, enabling radio listeners to get people on the radio to slow down, pause, and repeat what they say in a manner that is conducive to improving the fluency of the radio listeners in the language being spoken on the radio.

The improved audio player capability is configured to enable each listener to adjust one or more aspects of the playing audio (e.g., speed, pauses, repetitions, and the like), to the current needs of each listener, thereby enabling different listeners with different levels of fluency of foreign languages to utilize the various aspects of the improved audio player capability for improving their fluency in the foreign languages.

The improved audio player capability depicted and described herein may be implemented for any suitable type of audio player. For example, the improved audio player capability may be implemented for compact disc players, radios (e.g., radios integrated with compact disc players, car radios, and the like), MP3 players, audio-player software applications, and/or any other hardware device or software application capable of playing non-broadcast and/or broadcast audio.

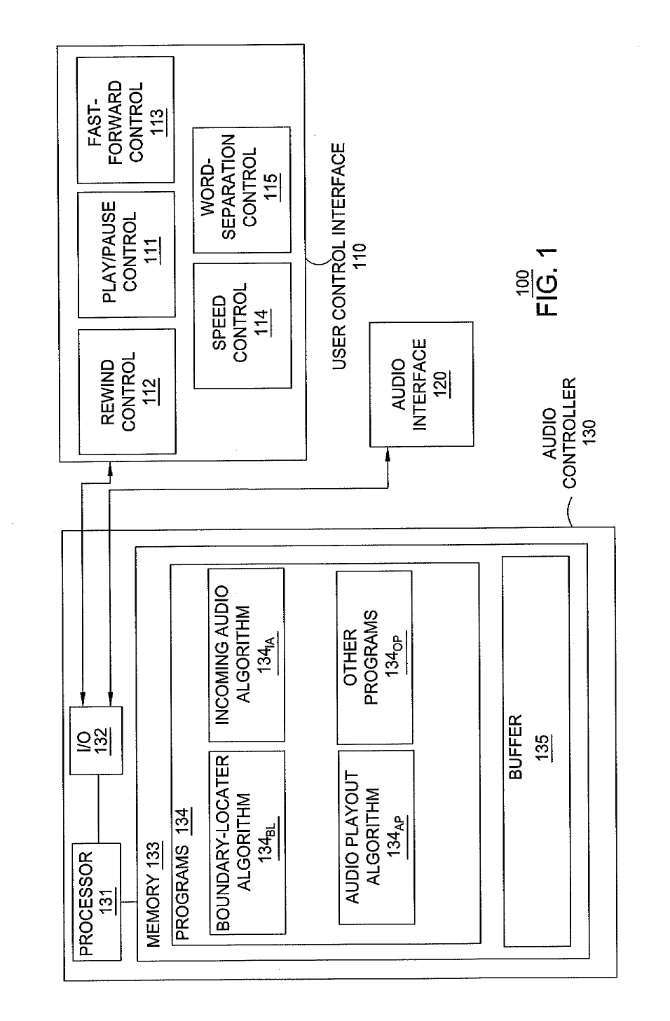

FIG. 1 depicts a high-level block diagram of one embodiment of an audio player.

The audio player 100 may be any type of audio player. For example, the audio player 100 may be a compact disc player, a radio (e.g., a radio integrated with a compact disc player, a car radio, and the like), an MP3 player, an audio-player software application running on a computer, and the like.

The audio player 100 includes a user control interface 110, an audio interface 120, and an audio controller 130.

The user control interface 110 includes audio playout control mechanisms configured for use by a user in controlling audio playout via audio interface 120.

The user control interface 110 includes a play/pause control 111 for playing/pausing the audio, a rewind control 112 for setting the playout point to an earlier moment in the audio (which may be limited based on playout buffer size), and a fast-forward control 113 for setting the playout point to a later moment in the audio (which may be limited based on playout buffer size).

The user control interface 110 also may include one or both of a speed control 114 for adjusting the speed of the audio (without introducing any noticeable change of pitch) and a word-separation control 115 for adjusting the separation between adjacent words of the audio.

In this manner, the improved audio player capability augments existing audio play controls (e.g., play/pause, rewind/fast-forward, and the like) with one or more additional controls which may include one or both of an audio speed control and a word-separation control.

In one embodiment, audio player 100 supports four controls as follows: the play/pause control 111, the rewind control 112, the fast-forward control 113, and the speed control 114 for adjusting the speed of the audio without introducing any noticeable change of pitch. The use of this combination of controls may be based, at least in part, on an observation that, for a person learning a foreign language, when the person talks to a native speaker of that language, the person often asks the native speaker to slow down, pause, and/or to repeat what was previously said by the native speaker.

The inventor has realized, however, that in many cases slowing down the speed of the audio does not improve comprehension of the audio, and may even actually decrease comprehension of the audio. The inventor also has realized that this may be because when a person says “please slow down” to a foreign language speaker, the person does not simply mean “please slow down”; rather, the person really means “please slow down and also increase the pauses between your words.” The inventor has realized that the latter action, in most cases, is actually more important for increased comprehension. Accordingly, various embodiments audio player 100 may include word-separation control 115.

In one embodiment, for example, audio player 100 supports four controls as follows: the play/pause control 111, the rewind control 112, the fast-forward control 113, and the word-separation control 115.

In one embodiment, for example, audio player 100 supports five controls as follows: the play/pause control 111, the rewind control 112, the fast-forward control 113, the speed control 114, and the word-separation control 115.

Thus, it will be appreciated that word-separation control 115 may be used independent of or in conjunction with speed control 114.

As noted above, the use of such combinations of controls may be based, at least in part, on an observation that when a person talks to a native speaker of a foreign language, the person may need the native speaker to slow down and increase the pauses between words in order to increase the listening comprehension of the person.

In such embodiments, the speed of the audio may be adjusted in any suitable manner.

In such embodiments, the word-separation of the audio may be adjusted in any suitable manner. In one embodiment, word-separation control 115 may be configured for adjusting the separation between pairs of adjacent words by the same separation amount independent of syntactic relationships between adjacent words. In one embodiment, word-separation control 115 may be configured for adjusting the separation between adjacent words by an amount that is a function of the syntactic relationship between adjacent words (e.g., such as where the separation between the last word of one sentence and the first word of the next sentence is increased by a greater amount than the separation between a preposition and the adjacent grammatical object). The word-separation of the audio may be adjusted in any suitable manner, as described herein.

The audio interface 120 is configured for playing audio. For example, audio interface 120 may include one or more speakers for playing audio.

The audio controller 130 is configured for controlling playout of audio to audio interface 120 based on user input received from user control interface 110.

The audio controller 130 includes a processor 131, an input-output (I/O) interface 132, and a memory 133. The processor 131 is coupled to both I/O interface 132 and memory 133. The processor 131 is configured for controlling audio controller 130. The I/O interface 132 is configured for receiving user input from user control interface 110 and providing the user input to processor 131 for processing of the user input. The I/O interface 132 is configured for receiving audio during audio playout and providing the audio to audio interface 120 for playout of the audio. The memory 133 stores information in support of audio playout control functions provided by audio controller 130.

The memory 133 stores programs 134 and a buffer 135. Although depicted and described with respect to a single memory, it will be appreciated that any suitable number of memory components may be used for storing programs 134, buffer 135, and any other software, content, and the like which may be associated with audio playout.

The programs 134 include a boundary-locator algorithm 134_{BL}, an audio playout algorithm 134_{AP}, an incoming audio algorithm 134_{IA}, and other programs 134_{OP}. The boundary-locator algorithm 134_{BL} is configured for locating word boundaries between adjacent words of audio stored within buffer 135. The audio playout algorithm 134_{AP} is configured for playing audio from buffer 135. The incoming audio algorithm 134_{IA} is configured for processing incoming audio for storage in buffer 135. The other programs 134_{OP} may be configured to provide any other suitable functions for audio player 100.

The buffer 135 is configured for storing audio for playout via audio interface 120, where playout is based on signals received from user control interface 110. As described above, the buffering of incoming audio within buffer 135, processing of audio buffered with buffer 135, and playout of audio buffered within buffer 135 may be controlled using various programs 134.

The boundary-locator algorithm 134_{BL} is configured for locating word boundaries between adjacent words of audio buffered in or intended to be buffered in buffer 135, and associating boundary markers with identified word boundaries.

The boundary-locator algorithm 134_{BL} may utilize various aspects of computer speech recognition for providing the improved audio player capability.

As will be understood by one skilled in the art, computer speech recognition may be categorized based on four orthogonal properties, as follows:

(1) Continuation/Non-Continuous: A continuous recognizer can effectively process speech as it is normally spoken. A non-continuous recognizer requires that the speaker intentionally insert a noticeable pause after many or most words, and enunciate words more clearly than is the case in normal speech;

(2) Speaker-Independent/Speaker-Dependent: A speaker-independent recognizer can effectively process a wide range of speakers without requiring any prior training. A speaker-dependent recognizer can effectively process only those particular speakers with whom it has had prior training;

(3) Real-Time/Non-Real-Time: A real-time recognizer can effectively process speech at the rate at which it is spoken. A non-real-time recognizer is slower, and typically processes speech off-line; and

(4) Large-Vocabulary/Restricted-Vocabulary: A large-vocabulary recognizer can effectively process speech whose vocabulary is drawn from a large corpus. A restricted-vocabulary recognizer can handle only a small, pre-determined corpus.

In each of the above four cases, the property that is more difficult to implement is listed first. Hence, the hardest speech recognizer to implement is one that is continuous, speaker-independent, real-time, and large-vocabulary. As far as the inventor is aware, there are no speech recognizers that are able to simultaneously satisfy all four of those properties to the degree required to process arbitrary normal speech spoken by arbitrary normal speakers—which is precisely the kind of speech contained in radio broadcasts. Fortunately, implementation of boundary-locator algorithm 134_{BL} for providing the improved audio player capability does not require such a computer speech recognizer, i.e., a continuous, speaker-independent, real-time, large-vocabulary speech recognizer. Specifically, the computer speech recognizer that is used to implement the boundary-locator algorithm 134_{BL} for providing the improved audio player capability is not required to run as a real-time speech recognizer. Additionally, the computer speech recognizer that is used to implement the boundary-locator algorithm 134_{BL} for providing the improved audio player capability does not even require other functions usually provided by computer speech recognizers. For example, a function of most computer speech recognizers is to determine the sequence of words that is included in the utterance of the audio that is being analyzed. However, in at least some embodiments of the boundary-locator algorithm 134_{BL} there is no need for any identification of the words in the utterance of the audio that is being analyzed; rather, various embodiments of the boundary-locator algorithm 134_{BL} only have to identify boundaries between words in the utterance of the audio that is being analyzed, without regard for the actual words of the utterance. It will be appreciated that although such functions are not required for the computer speech recognizer that is used to implement the boundary-locator algorithm 134_{BL} for providing the improved audio player capability, the computer speech recognizer that is used to implement the boundary-locator algorithm 134_{BL} for providing the improved audio player capability may include such functions.

In one embodiment, the boundary-locator algorithm 134_{BL} that is used to provide the improved audio player capability is a continuous, speaker-independent, non-real-time, large-vocabulary, error-permitting, word-boundary locator.

In this embodiment, the continuous, speaker-independent, non-real-time, large-vocabulary, error-permitting, word-boundary locator may be implemented in any suitable manner.

In one embodiment, for example, since the boundary-locator algorithm 134_{BL} is allowed to err and is not required to run in real-time, the boundary-locator algorithm 134_{BL} may simply search the audio for various natural pauses that people tend to insert into speech, such as between key words and phrases. It will be appreciated that, while this type of boundary-locator algorithm may not detect all word boundaries (e.g., due to things such as co-articulation, where people run many of their words together), it will detect enough word boundaries to significantly improve listening comprehension.

In one embodiment, for example, the boundary-locator algorithm 134_{BL} may utilize a computer speech recognition algorithm that is configured for detecting boundaries between adjacent words, including boundaries between co-articulated words.

It will be appreciated that, while the boundary-locator algorithm 134_{BL} is not required to locate every word boundary in the audio being analyzed in order to provide the improved audio player capability, the identification of a greater number of word boundaries by the boundary-locator algorithm 134_{BL} may enable the improved audio player capability, that is implemented using the boundary-locator algorithm 134_{BL}, to provide a greater level of listening comprehension.

Similarly, it will be appreciated that, while the boundary-locator algorithm 134_{BL} is allowed to err by falsely identifying word boundaries that are not actually between adjacent words, identification of such false word boundaries will not necessarily negatively impact listening comprehension, although a reduction in the number of false word boundaries detected by the boundary-locator algorithm 134_{BL} may enable the improved audio player capability, that is implemented using the boundary-locator algorithm 134_{BL}, to provide a greater level of listening comprehension.

In one embodiment, in which the boundary-locator algorithm 134_{BL} is implemented using a computer speech recognition algorithm, audio player 100 may include a transcoder for enabling audio player 100 to handle a larger number of audio encoding types than might otherwise be supported by the underlying computer speech recognition algorithm. This transcoding may be required if the existing computer speech recognition algorithms are designed only to handle only a subset of the full set of possible audio encoding types. For example, Dragon Naturally Speaking, from www.nuance.com, can handle MP3 and other audio encoding types, but cannot handle AAC. If the boundary-locator algorithm 134_{BL} is derived from a computer speech recognition algorithm that cannot handle the audio encoding type of the audio to be played at the audio player 100, the audio player 100 uses the transcoder for converting the audio encoding type of the audio to an audio encoding type that is supported by the computer speech recognition algorithm from which boundary-locator algorithm 134_{BL} is derived and, thus, is supported by the boundary-locator algorithm 134_{BL}. The transcoder may be any suitable transcoder type (e.g., the MP3-AAC transcoder that is available from www.aactomp3converter.com or any other suitable transcoder).

In one embodiment, the improved audio player capability is provided by running boundary-locator algorithm 134_{BL} on the audio stream as it arrives at the audio player 100, inserting boundary markers into the audio stream to form a boundary-marked audio stream, and storing the boundary-marked audio stream in the buffer 135 from which the boundary-marked audio stream may be played out.

In certain implementations of this embodiment, however, certain problems may arise. First, since the boundary-locator algorithm 134_{BL} is not required to run in real time, no matter how far the boundary-locator algorithm 134_{BL} is ahead of the playout point, playout of the audio may eventually catch up with the boundary-locator algorithm 134_{BL}, at which point problems may arise. Second, such an embodiment requires boundary-locator algorithm 134_{BL} to process every word in the audio stream, regardless of whether or not the user listens to every word in the audio stream, and boundary-locators are generally CPU-intensive. This would be acceptable if the number of CPU cycles available for implementing the improved audio player capability was significant; however, in many types of devices in which the improved audio player capability may be implemented (e.g., radios, handheld devices, and the like), CPU cycles are limited.

In one embodiment, the improved audio player capability is provided by running the boundary-locator algorithm 134_{BL} on the audio stream in a manner that increases the probability that the boundary-locator processes only those words of the audio stream to which the user actually listens. In one such embodiment, for example, the boundary-locator algorithm 134_{BL} may be configured for detecting portions of the audio that are unlikely to be listened to by the user (e.g., such as commercials) and removing from the buffer 135, or skipping over, those detected portions of the audio such that the boundary-locator algorithm 134_{BL} does not perform boundary location processing on those portions of the audio.

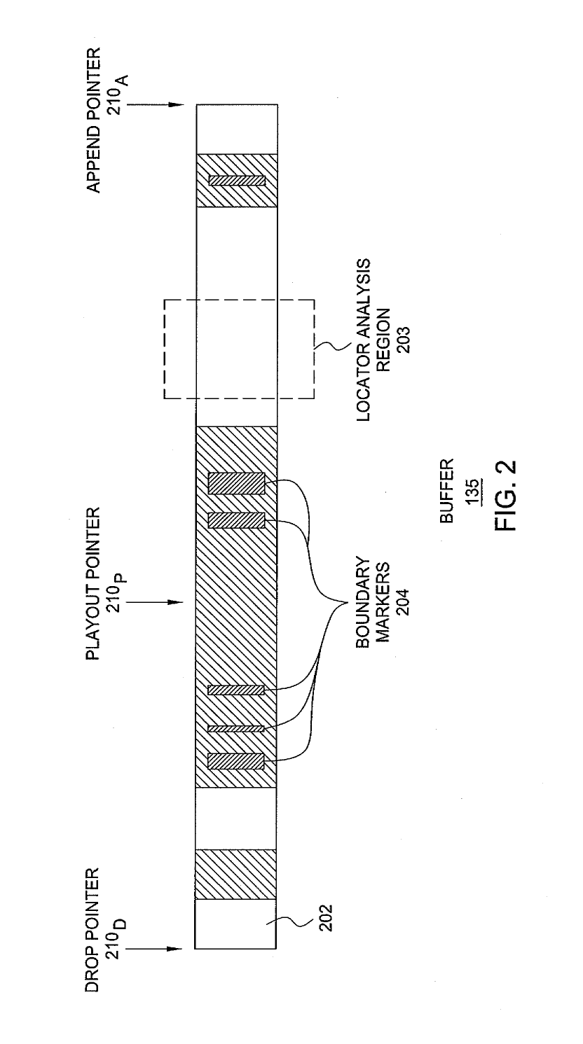

As described herein, the buffer 135 is configured for storing audio for playout via audio interface 120 based on signals received from user control interface 110. An exemplary buffer 135 is depicted and described with respect to FIG. 2.

FIG. 2 depicts one embodiment of a buffer for use in the audio player of FIG. 1.

As depicted in FIG. 2, buffer 135 stores, for an audio stream at the audio player 100, a digital encoding of the audio 202 and boundary markers 204 associated with the audio. A boundary marker 204 indicates a point in the audio that is deemed, by boundary-locator algorithm 134_{BL}, to be between two adjacent words of the audio.

The buffer 135 may be managed in any suitable manner. In one embodiment, at any given moment during the operation of the audio player 100, there are three pointers pointing into the buffer, as follows:

(1) Playout Pointer: This is a pointer to the current playout point in the buffer 135 (i.e., the point in the audio that is currently being played out via audio interface 120). As the audio is played out of the audio player 100 via audio interface 120, the playout pointer moves (e.g., illustratively, to the right). This is denoted as Playout Pointer 210_{P} in FIG. 2.

(2) Append Pointer: This is a pointer to the end of the buffer 135 at which received audio is appended to the buffer 135 for storage in the buffer 135. This is denoted as Append Pointer 210_{A} in FIG. 2.

(3) Drop Pointer: This is a pointer to the end of the buffer 135 from which audio is dropped. This is denoted as Drop Pointer 210_{D} in FIG. 2.

The buffer 135 may be implemented using any suitable type of buffer. In one embodiment, for example, the buffer 135 is organized as a circular buffer within a contiguous region of memory (illustratively, within memory 133 of audio player 100). It will be appreciated that any other suitable buffer implementations may be used.

The boundary markers 204 are identified and inserted into the buffer 135 by the boundary-locator algorithm 134_{BL}. As described herein, the boundary-locator algorithm 134_{BL} may be implemented using a computer speech recognizer, or at least using various functions of a computer speech recognizer.

The boundary markers 204 stored within buffer 135 have logical sizes associated therewith, respectively, where the size of a boundary marker 204 marking a boundary between adjacent words is indicative of the length of the desired pause between the adjacent words in the audio. The size of the boundary markers 204 also may be referred to herein as the thickness of the boundary markers 204, as the thickness of the boundary markers 204 within the buffer 135 may be used for indicating the lengths of the desired pauses between adjacent words for which the boundary markers 204 are identified, respectively.

In one embodiment, in which the boundary-locator algorithm 134_{BL} is implemented using a computer speech recognizer that does not support syntactic analysis, the thickness of the inserted boundary markers 204 may be the same for all of the inserted boundary markers 204, or the thickness of the inserted boundary markers 204 may be derived from a non-syntactic analysis of the audio (e.g., a non-syntactic analysis of the actual lengths of the pauses in the audio).

In one embodiment, in which the boundary-locator algorithm 134_{BL} is implemented using a computer speech recognizer supporting syntactic analysis, the results of syntactic analysis may be used to influence the thickness of the inserted boundary markers 204. In this embodiment, non-syntactic analysis also may be used in combination with syntactic analysis for determining the thickness of the inserted boundary markers 204. For example, thinner boundaries indicate word boundaries that should receive relatively shorter separation (e.g., boundaries between adjacent words within a sentence) and thicker boundaries indicate word boundaries that should receive relatively longer separation (e.g., boundaries between grammatical clauses or sentences).

In one embodiment, the buffer 135, at any given moment, is logically divided into some number of contiguous buffer regions. The contiguous buffer regions may be of a first type or a second type. The first type of buffer region (indicated by absence of shading in FIG. 2) is a region in which the boundary-locator algorithm 134_{BL} has been not yet been run on the audio stored within that region. The second type of buffer region (indicated by shading in FIG. 2) is a region in which the boundary-locator algorithm 134_{BL} has been run on the audio stored within that region, and has identified and marked all word boundaries that it is capable of locating. In buffer 135, each buffer entry is marked as being part of a first type buffer region or a second type buffer region. The Playout Pointer 210_{P} of the buffer 135 may point to a first type buffer region or to a second type buffer region.

The boundary-locator algorithm 134_{BL}, at any given moment, is analyzing audio of a currently selected locator analysis region 203 for identifying boundaries between adjacent words of the audio within the currently selected locator analysis region 203.

The currently selected locator analysis region 203 may be (1) an entire first type buffer region, or (2) a portion of a first type buffer region (as depicted in FIG. 2). The locator analysis region 203 may be any suitable size, which may be specific to the particular boundary-locator algorithm 134_{BL} being used. In one embodiment, for example, the locator analysis region 203 may span several seconds worth of buffered audio, although any other suitable locator analysis region sizes may be used. In general, locator analysis region 203 is typically (but not necessarily always) located ahead of the Playout Pointer 210p within the context of the timeline of the audio (illustratively, the locator analysis region 203 is located to the right of the Playout Pointer 210_{P} in FIG. 2). The boundary-locator algorithm 134_{BL} may analyze the audio of the currently selected locator analysis region 203 concurrently with playout of audio from buffer 135.

The boundary-locator algorithm 134_{BL}, upon identifying a boundary between adjacent words of the audio within the currently selected locator analysis region 203, inserts a boundary marker 204 of the appropriate thickness into buffer 135. In one embodiment, upon insertion of a boundary marker 204, boundary-locator algorithm 134_{BL} optionally also removes from the buffer 135 any audio words associated with the word boundary denoted by the inserted boundary marker 204. This removal may be performed in any suitable manner (e.g., by literally removing the word from the buffer, by marking an appropriate bit, and the like).

The boundary-locator algorithm 134_{BL} changes each of the analyzed buffer entries of the current locator analysis region 203 from being marked as being part of a first type buffer region to being marked as being part of a second type buffer region. This change of the type of buffer region for analyzed buffer entries may be performed incrementally as the boundary-locator algorithm 134_{BL} processes the buffer entries of the current locator analysis region 203 or may be performed upon completion of analysis of the audio within the currently selected locator analysis region 203.

The boundary-locator algorithm 134_{BL}, upon completing processing for the currently selected locator analysis region 203, moves the locator analysis region 203 to a new position within buffer 135. The boundary-locator algorithm 134_{BL} may select the new position for locator analysis region 203 in any suitable manner.

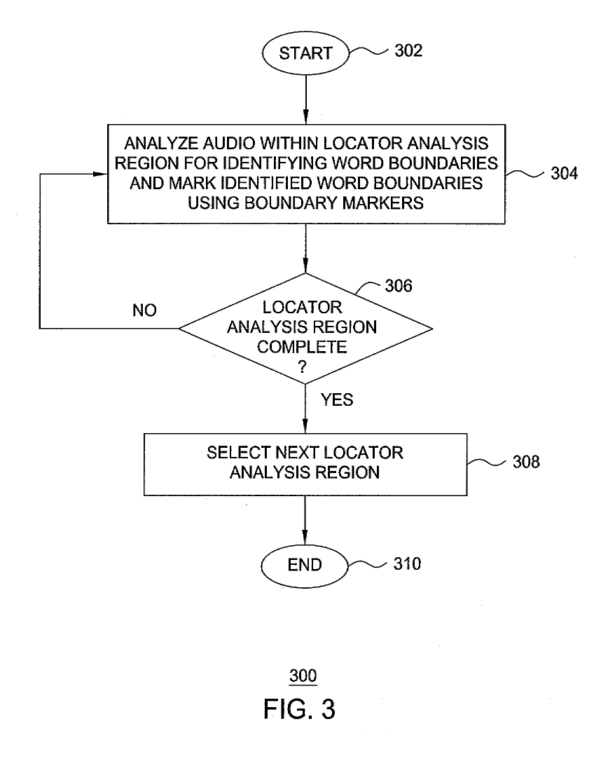

FIG. 3 depicts one embodiment of a method for analyzing audio within the buffer of FIG. 2 for identifying word boundaries and associating boundary markers with identified word boundaries. The audio that is analyzed is audio within a current locator analysis region 203 of buffer 135 of FIG. 2. In one embodiment, method 300 operates substantially as described above with respect to boundary-locator algorithm 134_{BL}.

At step 302, method 300 begins.

At step 304, audio within the locator analysis region 203 is analyzed for identifying word boundaries and marking identified word boundaries using boundary markers.

At step 306, a determination is made as to whether processing of audio of the locator analysis region 203 is complete, or should be prematurely terminated for some reason, e.g., as a result of a determination that the audio in that region has a low probability of being listened to by the user. If processing of the audio of the locator analysis region 203 is not complete or prematurely terminated, method 300 returns to step 304, at which point the audio within the locator analysis region 203 continues to be analyzed. If processing of the audio of the locator analysis region 203 is complete, the method 300 proceeds to step 308. In one embodiment, there may not be an explicit step of determining whether processing of audio of the locator analysis region 203 is complete; rather, the processing may merely continue until processing of all audio within the locator analysis region 203 is complete.

At step 308, a next locator analysis region 203 is selected. The next locator analysis region 203 may be selected in any suitable manner.

At step 310, method 300 ends.

Although depicted and described as ending, it will be appreciated that processing may continue as method 300 may be executed again on the next locator analysis region 203 that is selected for processing.

In this manner, the audio within the locator region 203 continues to be analyzed until processing of all audio within the locator analysis region 203 is complete, during which zero or more word boundaries may be identified and marked.

As described above, boundary-locator algorithm 134_{BL} may select the new position for locator analysis region 203 in any suitable manner.

In one embodiment, the new position for locator analysis region 203 is the first type region of buffer 135 that is to the right of Playout Pointer 210p and as close as possible to Playout Pointer 210p. This may be beneficial since such a region of buffer 135 includes words most likely to be listened to by the user and that have not yet been processed by the boundary-locator algorithm 134_{BL}. Disadvantageously, however, this embodiment may not work well in certain situations. For example, use of this embodiment with the audio playout algorithm 134_{AP} described herein may result in undesirable playout having frequent pausing and resuming.

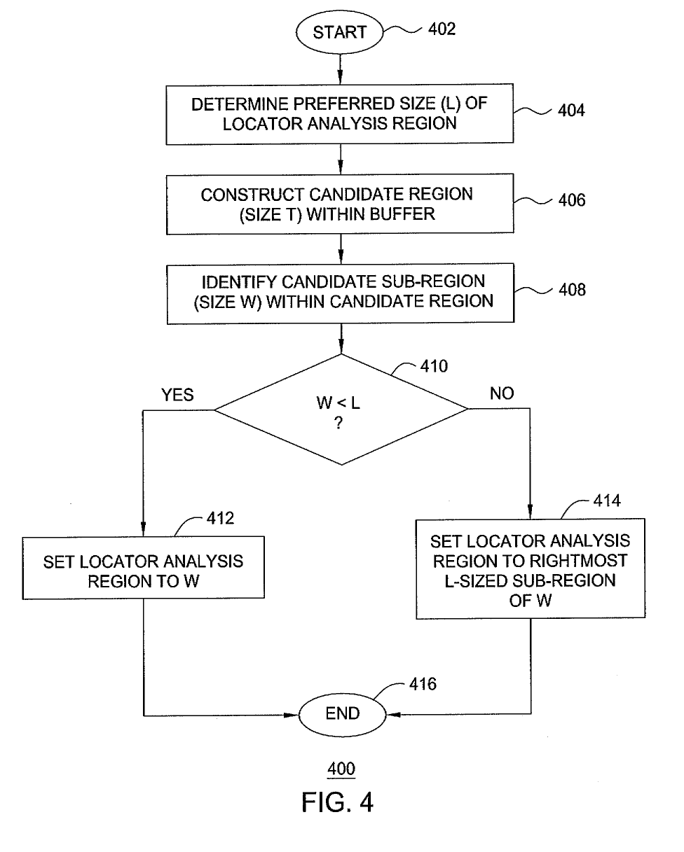

In one embodiment, in order to prevent undesirable playout effects, the new position for locator analysis region 203 is the first type region of buffer 135 that is to the right of Playout Pointer 210p but is not as close as possible to Playout Pointer 210_{P}. In this embodiment, the new position for locator analysis region 203 is farther to the right of Playout Pointer 210_{P}, and is then gradually moved leftward toward Playout Pointer 210p. This embodiment guarantees that when locator analysis region 203 finally reaches Playout Pointer 210_{P}, a sufficiently large second type region of buffer 135 exists to the right of Playout Pointer 210_{P}, i.e., large enough to minimize undesirable pauses. An exemplary embodiment is depicted and described with respect to FIG. 4.

FIG. 4 depicts one embodiment of a method for selecting a locator analysis region within the buffer of FIG. 2. The locator analysis region 203 that is selected is a region of buffer 135 of FIG. 2.

At step 402, method 400 begins.

At step 404, a preferred size (L) of the locator analysis region 203 is determined. The preferred size L of the locator analysis region 203 may be determined in any suitable manner (e.g., from memory, from a program, and the like). In one embodiment, the preferred size of the locator analysis region is a system-configured and locator-dependent value.

At step 406, a candidate region is constructed. The candidate region may include the portion of buffer 135 starting at Playout Pointer 210p and continuing rightward for at most T units of time (up to the end of the buffer, as indicated by Append Pointer 210_{A}). The value of T may be a system-configured constant which may be any suitable length of time (which may depend on the size of buffer 135 and/or one or more other factors).

At step 408, the rightmost sub-region within the candidate region that is a first type region (denoted as rightmost sub-region W) is identified.

At step 410, the size of rightmost sub-region W is compared to the value of preferred size L.

If the size of W is smaller than L, method 400 proceeds to step 412, at which point the new locator analysis region 203 is set to W. From step 412, method 400 proceeds to step 416, where method 400 ends.

If the size of W is greater than L, method 400 proceeds to step 414, at which point the new locator analysis region 203 is set to the rightmost L-sized sub-region of W. From step 414, method 400 proceeds to step 416, where method 400 ends.

At step 416, method 400 ends.

In this embodiment, by constraining the candidate region to be at most T units of time, it is possible to ensure that the locator analysis region 203 will gradually move leftward toward Playout Pointer 210p.

Returning now to FIG. 2, it will be appreciated that buffer 135, and the boundary-locator algorithm 134_{BL} which operates in conjunction with the buffer 135, may be implemented in any suitable manner.

Although primarily depicted and described herein with respect to embodiments in which a single buffer is used within audio player 100 in order to provide the improved audio player capability (e.g., storing both the audio stream and the boundary markers), in other embodiments two or more buffers may be used to provide the improved audio player capability (e.g., by storing the audio stream in a first buffer and storing the boundary markers for the audio stream in a second, parallel buffer associated with the first buffer).

Returning now to FIG. 1, the audio playout algorithm first 134_{AP} and the incoming audio algorithm 134_{IA} are described.

As described herein, audio playout algorithm 134_{AP} is configured for playing audio from buffer 135.

In the case in which the user is playing audio at normal speed, playout of the audio by audio playout algorithm 134_{AP} operates as follows. If the Playout Pointer 210_{P} is pointing to a first type buffer region, the audio player 100 plays silence, regardless of the contents of the buffer entry of buffer 135 to which Playout Pointer 210_{P} is currently pointing, and the Playout Pointer 210_{P} is not advanced. If the Playout Pointer 210_{P} is pointing to a second type buffer region, the audio player 100 plays the contents of the buffer entry, of buffer 135, to which Playout Pointer 210_{P} is currently pointing as follows: (a) if the buffer entry indicated by Playout Pointer 210_{P} is an audio word, the audio player 100 plays the audio word; (b) if the buffer entry indicated by Playout Pointer 210_{P} is an boundary marker 204, the audio player 100 plays silence. The audio player 100 may determine the amount of time for which to play silence for a boundary marker 204 in any suitable manner (e.g., by playing silence for an amount of time that is proportional to the thickness of the boundary marker 204, by playing silence for a user-configured amount of time where all boundary markers 204 have the same thickness, and the like). In these cases, advancement of Playout Pointer 210_{P} by audio playout algorithm 134_{AP} may be controlled as follows: (1) if the buffer entry just played was an audio word, Playout Pointer 210p is advanced by one buffer entry, unless Playout Pointer 210_{P} is at the end of buffer 135 in which case Playout Pointer 210_{P} is not advanced; (2) if the buffer entry just played was a boundary marker 204 within a first type buffer region, the Playout Pointer 210p is not advanced; (3) if the buffer entry just played was a boundary marker 204 within a second type buffer region, the audio playout algorithm 134_{AP} determines whether that boundary marker 204 that was played is the last boundary marker 204 within that second type buffer region, and then operates as follows: (3a) if it is the last boundary marker 204, the Playout Pointer 210p is not advanced, or (3b) if it is not the last boundary marker 204, the Playout Pointer 210_{P} is advanced by one buffer entry.

In the case in which the user is playing audio at other-than-normal speed (i.e., at slower-than-normal speed or faster-than-normal speed), the playout of the audio by audio playout algorithm 134_{AP} operates as described with respect to the case in which the user is playing audio at normal speed, except that the audio is played at the indicated speed with no noticeable pitch alteration. It will be appreciated that any suitable algorithm for playing audio at other-than-normal speed, without noticeably altering the pitch, may be used (e.g., using the myspeed algorithm available from www.enounce.com, using this capability from the Windows media player, and the like). In this case, in which the audio is being played at other-than-normal speed, the length of silence that is played for a boundary marker 204 is proportional to both the length of silence indicated by the boundary marker 204 (e.g., the thickness of the boundary marker 204) and the current audio playout speed setting.

In the case in which the user is rewinding, the audio playout algorithm 134_{AP} plays silence, and moves the Playout Pointer 210_{P} leftward in buffer 135 (until reaching the left end of the buffer 135, as indicated by Drop Pointer 210_{D}).

In the case in which the user is fast-forwarding, the audio playout algorithm 134_{AP} plays silence, and moves the Playout Pointer 210p rightward in buffer 135 (until reaching the right end of the buffer 135, as indicated by Append Pointer 210_{A}).

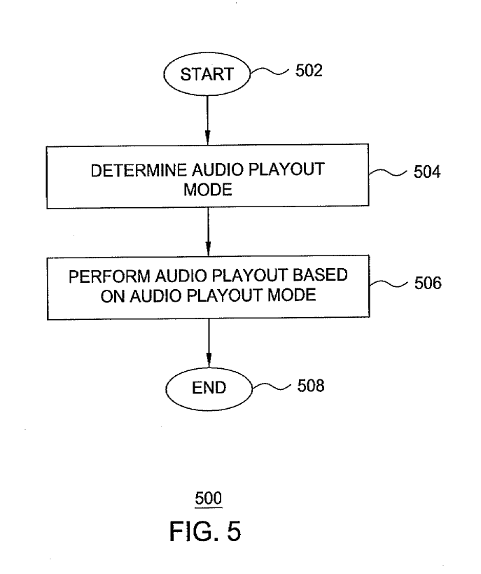

As described above, the operation of audio playout algorithm 134_{AP} depends on the playout mode currently selected at audio player 100. An exemplary embodiment for audio playout algorithm 134_{AP} is depicted and described with respect to FIG. 5.

FIG. 5 depicts one embodiment of a method for playing audio from a buffer. In one embodiment, method 500 operates substantially as described above with respect to audio playout algorithm 134_{AP}.

At step 502, method 500 begins.

At step 504, the audio playout mode is determined. As described above with respect to audio playout algorithm 134_{AP}, the audio playout modes may include playout at normal speed, playout at other-than-normal speed, rewind, and fast-forward.

At step 506, audio playout is performed in accordance with the audio playout mode, as described above with respect to audio playout algorithm 134_{AP}.

At step 508, method 500 ends.

Although primarily depicted and described with respect to specific audio playout algorithms, it will be appreciated that any suitable audio playout algorithm may be used in conjunction with word-separation control functions depicted and described herein.

As described herein, incoming audio algorithm 134_{IA} is configured for processing incoming audio for storage in buffer 135.

In one embodiment, handling of incoming audio depends on whether the audio is broadcast audio or non-broadcast audio. In the case of broadcast audio, the audio source (e.g., a radio broadcast station or other suitable audio broadcast source) pushes a steady stream of audio words to the audio player 100 (i.e., the audio player 100 typically cannot pause, or change the rate or timing of, the audio words that it receives). In the case of non-broadcast audio, the audio player 100 pulls audio words on demand from the audio source (e.g., a local memory on the audio player 100, a memory of a system associated with the audio player 100, a compact disc where the audio player 100 is or forms part of a compact disc player, or other suitable audio source).

In the case of broadcast audio, when an audio word arrives at the audio player 100, the incoming audio algorithm 134_{IA} attempts to store the audio word within buffer 135.

If there is space available in buffer 135 for the audio word, the incoming audio algorithm 134_{IA} stores the audio word in buffer 135 by appending the audio word to the buffer 135 (e.g., at the append point, as indicated by Append Pointer 210_{A}), and marks the audio word as being part of the first type buffer region (i.e., the region in which the boundary-locator algorithm 134_{BL} has not yet been run).

If there is insufficient space available in buffer 135 for the audio word, the incoming audio algorithm 134_{IA} operates as follows: (a) if the drop point (as indicated by Drop Pointer 210_{D}) is located within the locator analysis region 203, the incoming audio algorithm 134_{IA} drops the incoming audio work, (b) if the distance from the drop point to the playout point is less than a configurable amount of time R, the incoming audio algorithm 134_{IA} drops the incoming audio work, (c) otherwise, the incoming audio algorithm 134_{IA} drops the oldest audio word or boundary marker (at the drop point, as indicated by Drop Pointer 210_{D}) and then appends the new audio word to the buffer 135 (e.g., at the append point, as indicated by Append Pointer 210_{A}). In this case, the variable R operates as a rewind cushion, increasing the probability that the user of the audio player 100 will be able to rewind to the beginning of a section of audio that he or she did not understand. In one embodiment, audio player 100 also may be configured to enable user control of the value of R (in addition to enabling user control of the already mentioned five controls). In this embodiment, a user who often rewinds relatively far as compared to the size of buffer 135 is able to set variable R to an appropriately large value. In this embodiment, control of the variable R, as with other user controls depicted and described herein, may be provided to the user in any suitable manner.

In the case of non-broadcast audio, when the Playout Pointer 210_{P} gets within a pre-configured distance of the Append Pointer 210_{A}, incoming audio algorithm 134_{IA} requests a block of audio words from the audio source and, upon receiving the requested block of audio words, the incoming audio algorithm 134_{IA} operates as described hereinabove with respect to the case of broadcast audio by attempting to store each audio word of the block of audio words within buffer 135.

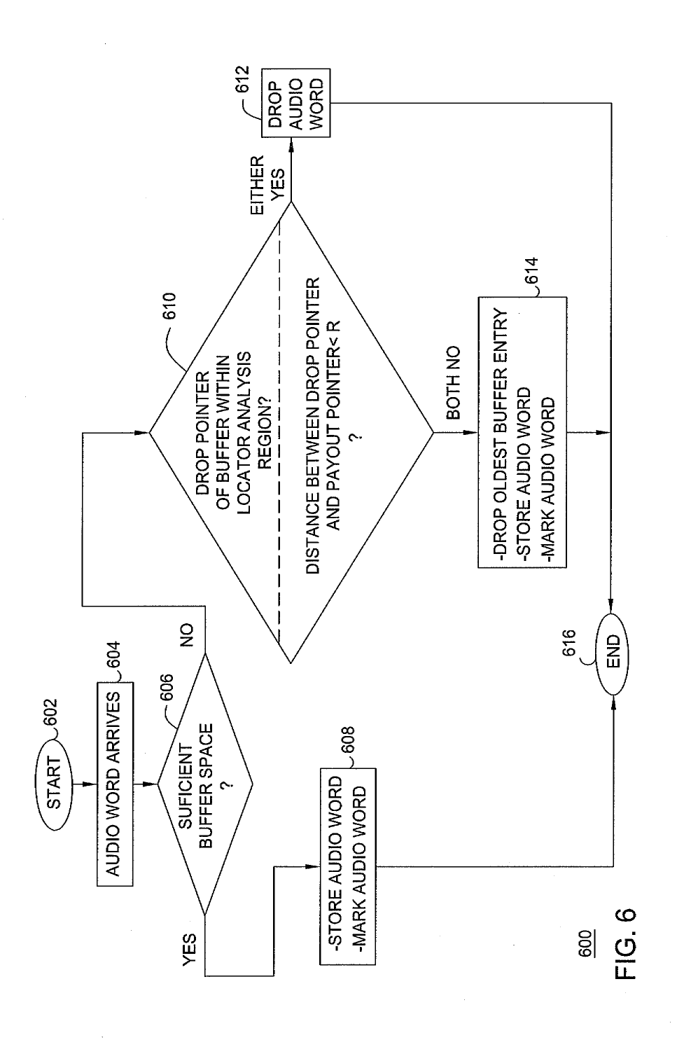

An exemplary embodiment for processing incoming audio word for storage in buffer 135 is depicted and described with respect to FIG. 6.

FIG. 6 depicts one embodiment of a method for processing an incoming audio word for storage within the buffer of FIG. 2. In one embodiment, method 600 operates substantially as described above with respect to incoming audio algorithm 134_{IA} for audio words of non-broadcast and broadcast audio.

At step 602, method 600 begins.

At step 604, an audio word arrives for storage in buffer 135. The audio word may arrive from any suitable non-broadcast or broadcast audio source.

At step 606, a determination is made as to whether there is sufficient space in buffer 135 for the audio word. If there is sufficient space, method 600 proceeds to step 608. If there is insufficient space, method 600 proceeds to step 610.

At step 608, when there is sufficient space available in buffer 135 for the audio word, the audio word is stored in buffer 135 by appending the audio word to the buffer 135 at Append Pointer 210_{P}, and the audio word is marked as being part of a region of buffer 135 in which the boundary-locator algorithm 134_{BL} has not yet been run. From step 608, method 600 proceeds to step 616, where method 600 ends.

At step 610, when there is insufficient space available in buffer 135 for the audio word, one or both of the following two determinations are made: (1) a determination as to whether Drop Pointer 210_{D} of the buffer 135 is located within the locator analysis region 203 of the buffer 135 and (2) a determination as to whether a distance from Drop Pointer 210_{D} to Playout Pointer 210_{P} is less than a configurable value R. If the result of either determination is YES, method 600 proceeds to step 612. It will be appreciated that, since only one determination needs to have a result of YES in order for the method 600 to proceed to step 612, either determination may be performed before the other.

If the result of both determinations is NO, method 600 proceeds to step 614.

At step 612, the audio word is dropped. From step 612, method 600 proceeds to step 616, where method 600 ends.

At step 614, the oldest buffer entry (audio word or boundary marker 204) is dropped from buffer 135, and the following steps are performed: (a) the arriving audio word is stored in buffer 135 by appending the arriving audio word to the buffer 135 at Append Pointer 210_{P}, and (b) the arriving audio word is marked as being part of a region of buffer 135 in which the boundary-locator algorithm 134_{BL} has not yet been run. From step 614, method 600 proceeds to step 616, where method 600 ends.

At step 616, method 600 ends.

Although depicted and described as ending (for purposes of clarity), it will be appreciated that method 600 continues to be performed for each audio word arriving for storage in buffer 135.

If the embodiment of FIG. 6 is used for the incoming audio algorithm 134_{IA}, it may be possible for the incoming audio algorithm 134_{IA}, under certain conditions, to alternately drop a few incoming audio words, then append a few incoming words, then drop a few words, and so on, such that the resulting audio that is played out from the audio player 100 would be choppy and, thus, unpleasant to the listener. In one embodiment, in order to prevent this effect, the incoming audio algorithm 134_{IA} is modified as follows: when the incoming audio algorithm 134_{IA} drops an incoming audio word after having appended the previous incoming audio word, the incoming audio algorithm 134_{IA} also drops a configurable number of the following audio words (i.e., the next X audio words received for processing by incoming audio algorithm 134_{IA}). By dropping an entire block of audio words in this manner, the playout point is given a chance to catch up, thereby decreasing the likelihood of the above-described effect of alternating drop and append operations (i.e., thereby decreasing the likelihood that the audio will become riddled with holes). It will be appreciated that, while the dropped block of audio is lost, in many cases it may be desirable to have a short block of lost audio, rather than having an unboundedly long block of choppy audio.

As described herein, concurrent with the audio playout algorithm 134_{AP} and the incoming audio algorithm 134_{IA}, the boundary-locator algorithm 134_{BL} is analyzing the audio in the current boundary-locator region 203, as depicted and described with respect to FIG. 2.

Although primarily depicted and described herein with respect to embodiments in which the programs 135 operate on a word-by-word basis, in other embodiments the programs 135 may operate on blocks of words where each block of words may include any suitable number of words.

Although primarily depicted and described with respect to providing slower-than-normal speed, it will be appreciated that the audio speed also may be controlled in a manner for providing faster-than-normal speed. In this manner, any suitable range of speeds may be provided.

Although primarily depicted and described with respect to providing longer-than-normal separation between words, it will be appreciated that the word-separation also may be controlled in a manner for providing shorter-than-normal separation between words. In this manner, any suitable range of word-separation lengths may be provided.

As described herein, the audio player 100 may be implemented as any suitable audio player (e.g., CD player, car radio, MP3 player, and the like). As such, the user interface for providing user control over the audio player, including speed control and word-separation controls, may be any suitable user interface which may be associated with any such audio player.

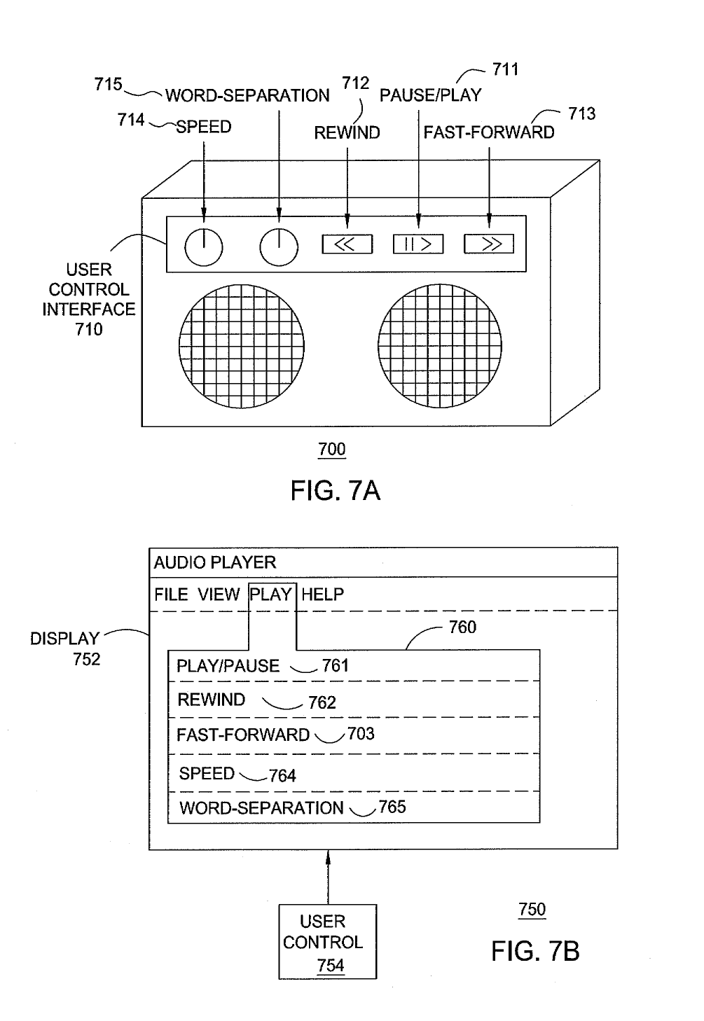

FIGS. 7A and 7B depict exemplary user control interfaces for the audio player of FIG. 1.

FIG. 7A depicts an exemplary user control interface for an exemplary audio player. As depicted in FIG. 7A, exemplary audio player 700 includes a user control interface 710 and speakers 720. The user control interface 710 includes a play/pause button 711 for playing/pausing audio, a rewind button 712 for rewinding audio, a fast-forward button 713 for fast-forwarding audio, a speed control dial 714 for setting the speed of playout of audio, and a word-separation control dial 715 for setting the word-separation of audio. The design and operation of user control interface 710 will be understood. It will be appreciated that, as with play/pause, rewind, and fast-forward controls, the speed control and word-separation control may be implemented using any suitable control mechanisms (e.g., buttons, dials, and the like, as well as various combinations thereof).

FIG. 7B depicts an exemplary user control interface for an exemplary audio player. As depicted in FIG. 7B, exemplary audio player 750 is presented on a display 752 configured for being controlled via a user control 754. For example, exemplary audio player 750 may be an application configured for being displayed on display 752 (e.g., a computer monitor) and controlled via user control 754 (e.g., a mouse of a computer). The exemplary audio player 750 includes a user control interface 760, implemented as a Graphical User Interface (GUI). The user control interface 760 includes a number of menu items, including FILE, VIEW, PLAY, and HELP menu items. The PLAY menu item is selected, resulting in display of sub-items available from the PLAY menu item, including a play/pause menu item 761 for playing/pausing audio, a rewind menu item 761 for rewinding audio, a fast-forward menu item 763 for fast-forwarding audio, a speed control menu item 764 for setting the speed of playout of audio, and a word-separation menu item 765 for setting the word-separation of audio. The design and operation of user control interface 760 will be understood. It will be appreciated that, as with play/pause, rewind, and fast-forward controls, the speed control and word-separation control may be implemented using any suitable GUI-based control mechanisms (e.g., icons, menu items, drop-down lists, radio buttons, check boxes, slide controls, and the like, as well as various combinations thereof).

In the exemplary embodiments of FIGS. 7A and 7B, as well as any other suitable implementations of the user control interface of audio player 100, the speed control and word-separation control may be providing using discrete settings available for selection by the user and/or continuous settings available for selection by the user.

Referring now to FIG. 1 in conjunction with FIGS. 7A and 7B, it will be appreciated that the speed settings and/or word-separation settings which may be controlled via the user control interface may include any suitable settings.

For example, the range of supported speed settings may range from 1× speed (i.e., normal speed) to ⅛^{th} speed, which may be provided in discrete increments (e.g., ⅛^{th} increments) or as a continuous range. Similarly, for example, the range of supported speed settings may range from 2× speed (i.e., faster-than-normal speed) to ¼^{th} speed, which may be provided in discrete increments (e.g., ¼^{th} increments) or as a continuous range. It will be appreciated that any other suitable speeds, which may include slower-than-normal and/or faster-than normal speeds, may be supported.

For example, the range of supported word-separation settings may range from 1× separation (i.e., the separation as spoken) to 4× separation (i.e., four times the length of the separation as spoken), which may be provided in discrete increments or as a continuous range. Similarly, for example, the range of supported word-separation settings may range from ½× separation (i.e., word-separation that is half as long as when spoken) to 2× separation (i.e., two times the length of the separation as spoken), which may be provided in discrete increments or as a continuous range. It will be appreciated that any other suitable ranges of word-separation, which may include longer-than-normal and/or shorter-than normal separation between words, may be supported.

Although primarily depicted and described herein with respect to specific user control interfaces and associated specific user control mechanisms, it will be appreciated that user-based control of speed and/or word-separation for audio playout may be implemented using any other suitable user control interfaces and associated user control mechanisms, which may vary for different types of audio players (e.g., CD players, radios, MP3 players, audio player software applications, and the like).

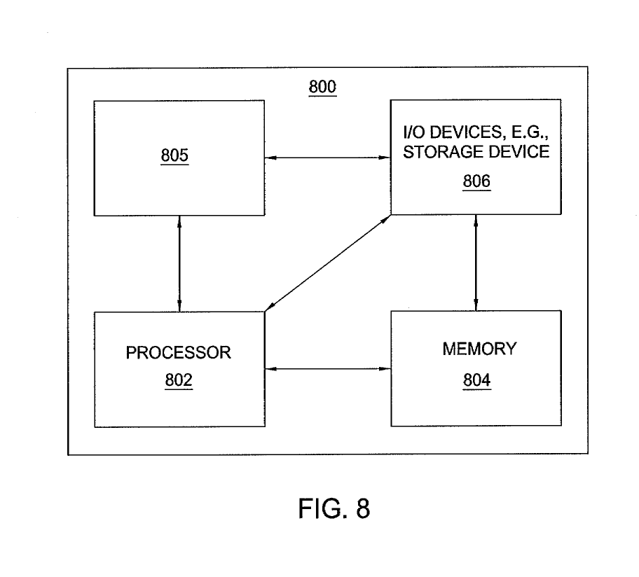

FIG. 8 depicts a high-level block diagram of a computer suitable for use in performing functions described herein.

As depicted in FIG. 8, computer 800 includes a processor element 802 (e.g., a central processing unit (CPU) and/or other suitable processor(s)), a memory 804 (e.g., random access memory (RAM), read only memory (ROM), and the like), an audio control module/process 805, and various input/output devices 806 (e.g., a user input device (such as a keyboard, a keypad, a mouse, and the like), a user output device (such as a display, a speaker, and the like), an input port, an output port, a receiver, a transmitter, and storage devices (e.g., a tape drive, a floppy drive, a hard disk drive, a compact disk drive, and the like)).

It will be appreciated that the functions depicted and described herein may be implemented in software and/or hardware, e.g., using a general purpose computer, one or more application specific integrated circuits (ASIC), and/or any other hardware equivalents. In one embodiment, the audio control process 805 can be loaded into memory 804 and executed by processor 802 to implement the functions as discussed herein. Thus, audio control process 805 (including associated data structures) can be stored on a computer readable storage medium, e.g., RAM memory, magnetic or optical drive or diskette, and the like.

It is contemplated that some of the steps discussed herein as software methods may be implemented within hardware, for example, as circuitry that cooperates with the processor to perform various method steps. Portions of the functions/elements described herein may be implemented as a computer program product wherein computer instructions, when processed by a computer, adapt the operation of the computer such that the methods and/or techniques described herein are invoked or otherwise provided. Instructions for invoking the inventive methods may be stored in fixed or removable media, transmitted via a data stream in a broadcast or other signal-bearing medium, and/or stored within a memory within a computing device operating according to the instructions.

Although various embodiments which incorporate the teachings of the present invention have been shown and described in detail herein, those skilled in the art can readily devise many other varied embodiments that still incorporate these teachings.

What is claimed is:

1. An apparatus, comprising:
a processor configured for controlling a length of separation between adjacent words of audio during playout of the audio.

2. The apparatus of claim 1, wherein the audio is stored in a buffer for playout.

3. The apparatus of claim 2, wherein the processor is configured for:
analyzing a locator analysis region of the buffered audio for identifying boundaries between adjacent words of the buffered audio; and
for each identified boundary between adjacent words of the buffered audio, associating a boundary marker with the identified boundary.

4. The apparatus of claim 3, wherein the locator analysis region of the buffered audio is analyzed using a speech recognition capability.

5. The apparatus of claim 4, wherein the speech recognition capability is a syntactic speech recognition capability, wherein the boundary marker has a thickness associated therewith, wherein the thickness of the boundary marker is determined based on syntactic analysis of the buffered audio.

6. The apparatus of claim 4, wherein the speech recognition capability is a non-syntactic speech recognition capability, wherein the boundary marker has a thickness associated therewith, wherein the thickness of the boundary marker is determined based on non-syntactic analysis of the buffered audio.

7. The apparatus of claim 3, wherein the buffer has associated therewith a playout pointer indicative of a current location of playout of audio from the buffer, wherein the locator analysis region of the buffer is set to be ahead of the playout pointer such that the locator analysis region is not adjacent to the playout pointer.

8. The apparatus of claim 7, wherein processor is configured for moving the locator analysis region toward the playout pointer as the audio of the buffer is analyzed for identifying boundaries between adjacent words.

9. The apparatus of claim 3, wherein the buffer has associated therewith a playout pointer indicative of a current location of playout of audio from the buffer, wherein the processor is configured for selecting the locator analysis region by:
constructing a candidate locator analysis region of the buffer, wherein the candidate locator analysis region begins at the playout pointer and ends T units of time ahead of the playout pointer; and
setting the locator analysis region to be the sub-region of the candidate locator analysis region that is adjacent to the end of the candidate locator analysis region that is farthest from the playout pointer and has not yet been analyzed.

10. The apparatus of claim 9, wherein the locator analysis region has a preferred size (L) associated therewith, wherein the processor is configured for setting the locator analysis region as being a sub-region of the candidate locator analysis region that is adjacent to the end of the candidate locator analysis region that is farthest from the playout pointer and has not yet been analyzed by:
identifying a candidate sub-region having a size W, wherein the candidate sub-region is adjacent to the end of the candidate locator analysis region that is farthest from the playout pointer; and
when L is greater than W, setting the locator analysis region to be the candidate sub-region;
when W is greater than L, setting the locator analysis region to be an L-sized sub-region of the candidate sub-region.

11. The apparatus of claim 3, wherein associating a boundary marker with the located boundary comprises one of:
inserting the boundary marker within the buffer, wherein the boundary marker is inserted within the buffer in the location of the identified word boundary; or
inserting the boundary marker within another buffer.

12. The apparatus of claim 3, wherein a boundary marker has a thickness associated therewith.

13. The apparatus of claim 12, wherein the length of the separation between adjacent words is controlled based on the thickness of the boundary marker.

14. The apparatus of claim 1, wherein the processor is configured for playing the audio from the buffer by:
identifying a location of a playout pointer of the buffer; and
playing out an entry indicated by the playout pointer.

15. The apparatus of claim 11, wherein, when playout of audio at normal speed is selected, the processor is configured for playing the audio from the buffer by:
when the playout pointer points to a region of the buffer in which word boundary identification processing has not been performed, silence is played irrespective of the contents of the buffer entry indicated by the playout pointer, and the playout pointer is not advanced;
when the playout pointer points to a region of the buffer in which word boundary identification processing has been performed, the contents of the buffer entry indicated by the playout pointer is played by:
when the buffer entry indicated by the playout pointer includes an audio word, the audio word is played;
when the buffer entry indicated by the playout pointer includes a boundary marker, silence is played.

16. The apparatus of claim 15, wherein the processor is configured for:
when the buffer entry indicated by the playout pointer includes an audio word, the playout pointer is advanced by one buffer entry;
when the buffer entry indicated by the playout pointer includes a boundary marker, determining whether the boundary marker for which silence is played is the last boundary marker within the region;
when the boundary marker for which silence is played is the last boundary marker within the region, the playout pointer is not advanced;
when the boundary marker for which silence is played is not the last boundary marker within the region, the playout pointer is advanced.

17. The apparatus of claim 1, wherein the length of separation between adjacent words of the audio is controlled in response to a control signal received from at least one user control mechanism.

18. The apparatus of claim 17, wherein at least one user control mechanism comprises at least one of a dial, a button, and a graphical user interface (GUI) control.

19. The apparatus of claim 1, wherein the audio comprises non-broadcast audio or broadcast audio.

20. A method, comprising:
controlling a length of separation between adjacent words of audio during playout of the audio.
